(19) United States
(12) Patent Application Publication
(10) Pub. No.: US 2026/0270716 A1
(43) Pub. Date: Sep. 10, 2026

(54) A METHOD FOR CONTROLLING A COVERAGE ENHANCING DEVICE, A METHOD FOR CONTROLLING A NODE, A COVERAGE ENHANCING DEVICE, AND A NODE

(71) Applicant: Sony Group Corporation, Tokyo (JP)

(72) Inventors: Erik BENGTSSON, Eslöv (SE); Fredrik RUSEK, Eslöv (SE); Jose FLORDELIS, Lund (SE)

(21) Appl. No.: 19/165,921

(22) PCT Filed: Mar. 19, 2024
(86) PCT No.: PCT/EP2024/057292

§ 371 Date: Sep. 16, 2025

(30) Foreign Application Priority Data
Mar. 31, 2023 (SE) 2350389-9

(51) Int. Cl. H04W 16/26; H04B 17/309; H04W 8/22; H04W 12/06; H04W 16/28

(52) U.S. Cl. CPC H04W 16/26; H04B 17/346; H04W 8/22; H04W 12/06; H04W 16/28

(57) ABSTRACT

Disclosed is a method, performed in a coverage enhancing device, CED, for enabling interference mitigation in a communication network. The method comprises detecting an interference in a signal received at the CED. The method comprises transmitting, to a node, information indicative of the interference detected by the CED.

The present disclosure pertains to the field of wireless communications and inference management. The present disclosure relates to a method for controlling a coverage enhancing device (CED), a method for controlling a node, a related CED and a node.

### BACKGROUND

In the field of wireless communications, environmental conditions, such as weather conditions, may influence how radio signals propagate, and remote nodes, such as remote radio network nodes, may create occasional interference. For example, when uplink, UL, and downlink, DL, slots of Time Division Duplexing, TDD, systems for different radio network nodes, such as gNodeBs, gNBs, overlap, interference may occur.

The 3rd Generation Partnership Project, 3GPP, supports a framework for interference mitigation, called the remote interference management, RIM, and cross-link interference, CLI, framework. The RIM/CLI framework targets radio network node to radio network node, such as gNB-to-gNB, interference. The framework enables the radio network nodes, such as gNBs, to communicate over the channel through which the interference propagates and enables them to synchronize or blank symbols to mitigate the problem.

However, interference mitigation remains challenging in the field of wireless communication. For example, with the development of CEDs in 3GPP it is more challenging and complex to detect and/or localize interference in a communication network.

### SUMMARY

When introducing a CED in a wireless communication system, additional interference may be introduced. For example, additional sources of interference and additional links where interference can be introduced may arise. Accordingly, there is a need for devices and methods for enabling interference mitigation in a communication network, which may mitigate, alleviate or address the shortcomings existing and may provide improved interference detection, localization, and mitigation.

Disclosed is a method, performed in a (such as by a) coverage enhancing device, CED, for enabling interference mitigation in a communication network, such as a wireless communication network. The method comprises detecting an interference in a signal received at the CED. The method comprises transmitting, to a node, information indicative of the interference detected by the CED.

Further, a CED comprising memory circuitry, processor circuitry, and a wireless interface is provided. The CED is configured to perform any of the methods disclosed herein and related to the CED.

It is an advantage of the present disclosure that the CED improves interference mitigation in a wireless communication network by detecting interference and transmitting information indicative of the interference to a node of the communication network. Further, the CED allows a node, such as a radio network node, a wireless device, and/or a CED controlling node, to improve a mitigation strategy for mitigating interference in the communication network, and in turn improving interference mitigation. For example, the present disclosure may allow interference mitigation such as time domain adjustment, blanking, updating beamforming configurations, and refraining from using the CED. It may be appreciated that the CED improves inference detection and localization in a wireless communication network. An advantage of the present disclosure is that inference detection, localization, and mitigation may be performed at a lower resource cost. Further, an advantage of the present disclosure is the provision of a greater and more detailed understanding of the interference situation in a wireless communication system.

Disclosed is a method performed in a node for enabling interference mitigation in a communication network. The method comprises receiving, from a coverage enhancing device, CED, information indicative of interference detected by the CED. The method comprises determining, based on the information, a mitigation strategy for mitigating the interference.

Further, a node comprising memory circuitry, processor circuitry, and a wireless interface is provided. The node is configured to perform any of the methods disclosed herein.

It is an advantage of the present disclosure that the node improves interference mitigation in a wireless communication network by receiving information indicative of interference detected by a CED and determining a mitigation strategy for mitigating the interference. For example, the present disclosure may allow interference mitigation such as time domain adjustment, blanking, updating beamforming configurations, and refraining from using the CED. It may be appreciated that the node improves inference detection and localization in a wireless communication network. An advantage of the present disclosure is that inference detection, localization, and mitigation may be performed at a lower resource cost. Further, an advantage of the present disclosure is the provision of a greater and more detailed understanding of the interference situation in a wireless communication system.

The present disclosure may allow improved beamforming in the communication system, such as beamforming of the CED and/or a radio network node. It is therefore an advantage of the present disclosure to save resources.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node, an example CED, and an example wireless device according to this disclosure,

FIGS. 2A-2B show a flow-chart illustrating an example method, performed in a CED, for enabling interference mitigation in a communication network, according to this disclosure,

FIGS. 3A-3B show a flow-chart illustrating an example method, performed in a node, for enabling interference mitigation in a communication network, according to this disclosure,

FIG. 4 is a diagram illustrating an example wireless communication system comprising an example network node, an example CED, and an example wireless device according to this disclosure, where an example technique as disclosed herein is applied,

FIGS. 5A-5B are diagrams illustrating example CEDs according to this disclosure,

FIG. 6 is a block diagram illustrating an example CED according to this disclosure, and

FIG. 7 is a block diagram illustrating an example node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

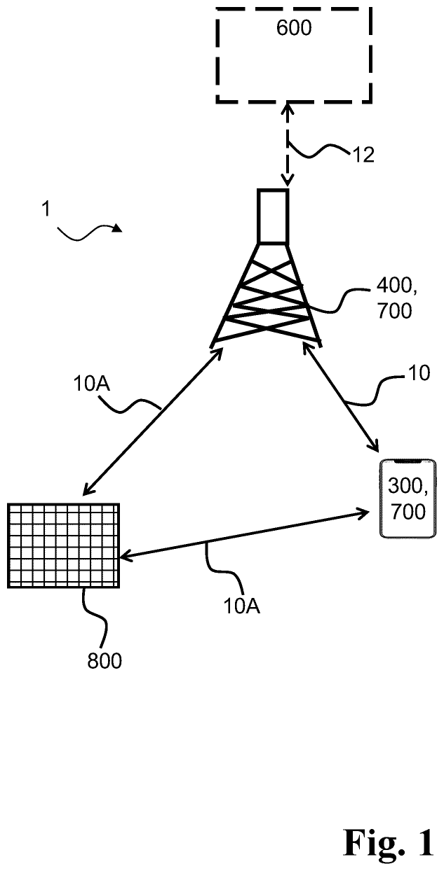

FIG. 1 is a diagram illustrating an example wireless communication system 1 according to this disclosure. The wireless communication system 1 comprises a wireless device 300, a network node 400 and a core network (CN) node 600.

As discussed in detail herein, the present disclosure relates to a wireless communication system 1 comprising a cellular system, for example, a 3GPP wireless communication system.

A network node disclosed herein refers to a radio access network (RAN) node operating in the radio access network, such as a base station, an evolved Node B, eNBs, a global Node B, gNBs in NR, and/or a transmission and reception point (TRP). In one or more examples, the RAN node is a functional unit which may be distributed in several physical units.

A CN node disclosed herein refers to a network node operating in the core network, such as in the Evolved Packet Core Network, EPC, and/or a 5G Core Network, 5GC. Examples of CN nodes in EPC include a Mobility Management Entity, MME.

In one or more examples, the CN node is a functional unit which may be distributed in several physical units.

The wireless communication system 1 described herein may comprise one or more wireless devices 300, and/or one or more network nodes 400, such as one or more of: a base station, an eNB, a global Node B, gNB, and/or an access point. The network node 400 may be seen as a radio network node.

A wireless device may refer to as a mobile device and/or a user equipment, UE.

The wireless device 300 may be configured to communication with the network node 400 via a wireless link (or radio access link) 10, 10A.

The wireless communication system 1 may comprise a coverage enhancing device (CED) 800. The CED 800 may be one or more of a smart repeater, a reflective intelligent surface (RIS), a network controlled repeater (NCR), and/or another wireless device (WD). The CED 800 may provide coverage enhancement for devices using 5G and beyond. The CED 800 may be configurable by the network node 400 and/or the CN node 600, and may be used to improve signal coverage in the wireless communication system 1. The CED 800 may be used to retransmit, such as forward, signals, such as data and/or control signals, between the network node 400 and the WD 300. The retransmission can be advantageous when the WD 300 is located at hard-to-reach locations, such as at a border of a coverage area of the network node 400 and/or when a direct link between the network node 400 and the WD 300 is obstructed. It may be appreciated that the CED 800 can also be used to increase the multiple components and/or channel rank to support MIMO communication between the network node 400 and the WD 300, even in a well-covered area. The CED 800 may comprise a plurality of antenna elements that can be configured with a respective phase shift. By controlling the phase shifts, such as jointly controlling the phase shifts, an incoming and/or outgoing angle of a signal received and/or transmitted by the CED 800 can be controlled and/or adapted. In one or more example methods, the angle of incoming and outgoing signals can be controlled by controlling the relative phase between antenna elements of the CED 800. The phase shift may be a capacitor-based phase shift and/or a true time delay line, such as a time domain shift, between antenna elements of the CED 800. The WD 300 may be configured to communicate with the network node 400 directly via the wireless link (or radio access link) 10 and/or via the CED 800 via wireless link 10A. The wireless link 10A may herein be referred to as a reflected, such as retransmitted, wireless link. The CED 800 may be controlled by one or more network nodes, such as the network node 400, or one or more wireless devices, such as the WD 300. The communication system 1 comprises a node 700. In one or more example methods, the node 700 may be seen as the network node 400 and/or the wireless device 300. In one or more example methods, the node 700 may be seen as a separate node, such as a CED controlling node and/or an interferer node. The one or more network nodes or wireless devices controlling the CED 800 may herein be referred to as coverage enhancing device controlling nodes. In one or more example methods, the coverage enhancing device controlling node can be a CN node, such as the CN node 600 in FIG. 1. In one or more example methods, the CED controlling node can be a node in an external network that can access the CED 800, for example through the internet via a gateway function and/or via a wireless control channel.

According to the current disclosure, the CED 800 may be configured, for example by the node 700 as disclosed herein, to detect interference in a signal received at the CED and to transmit information indicative of the detected interference to the node 700.

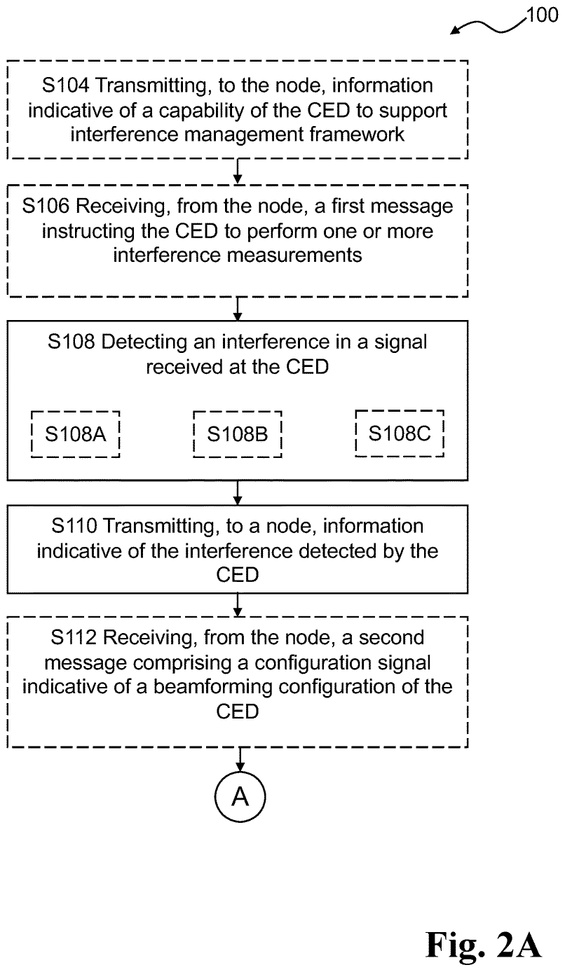

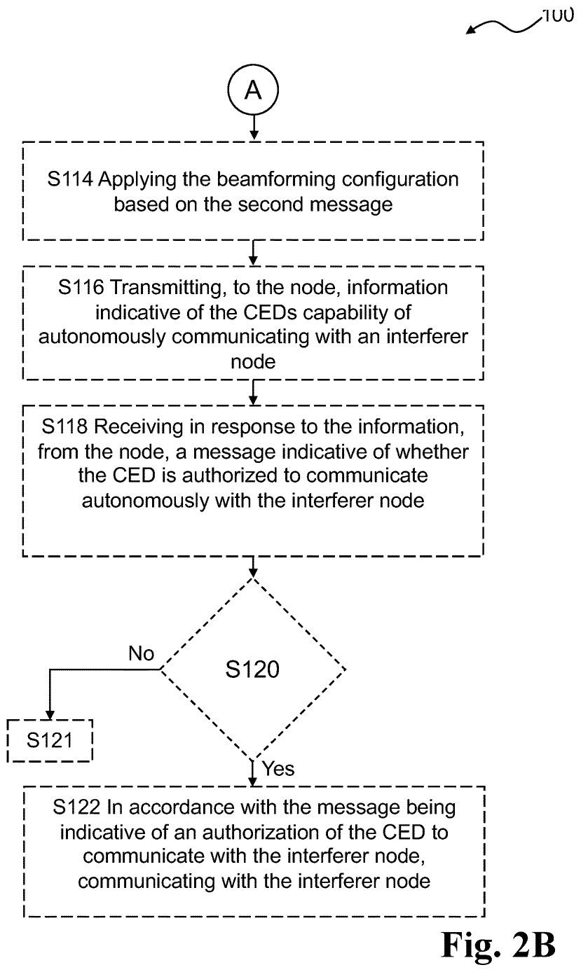

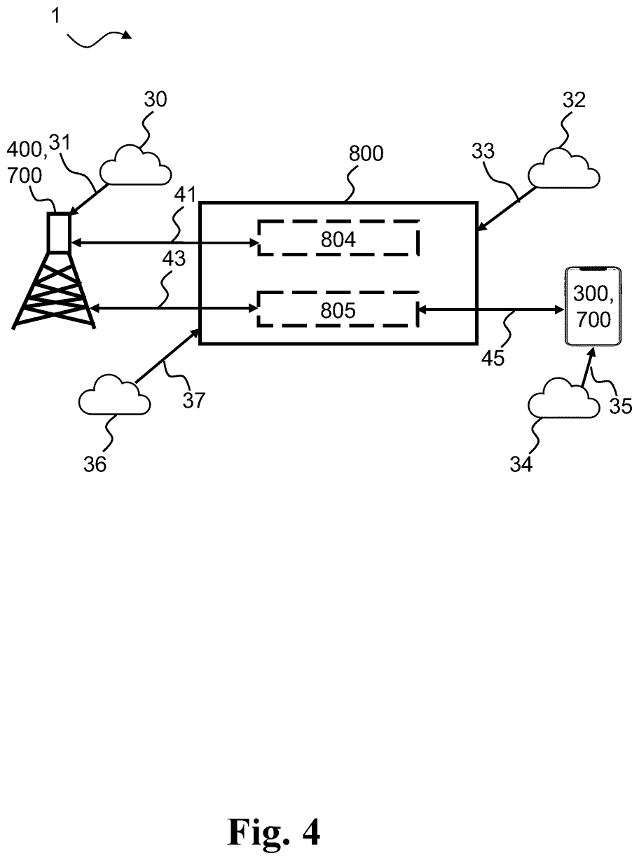

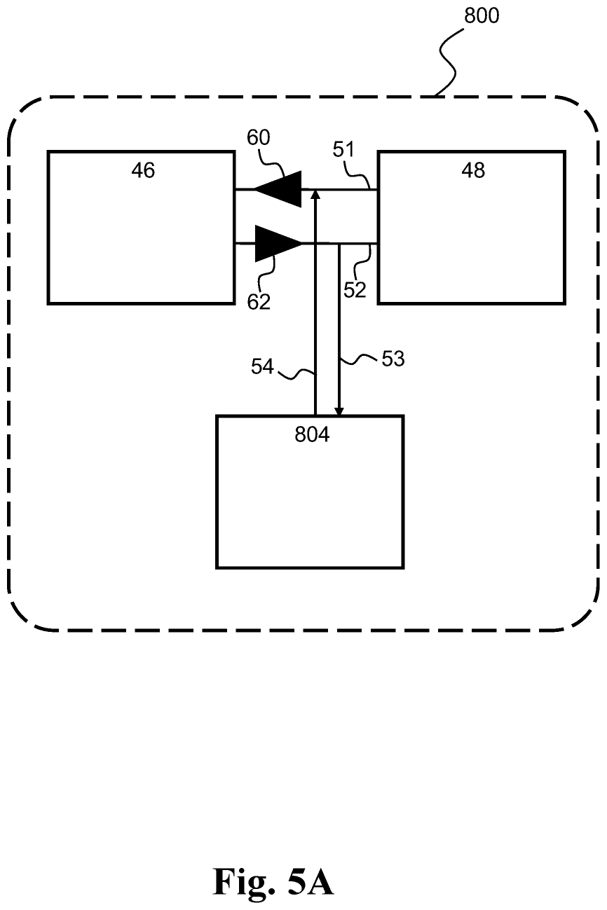

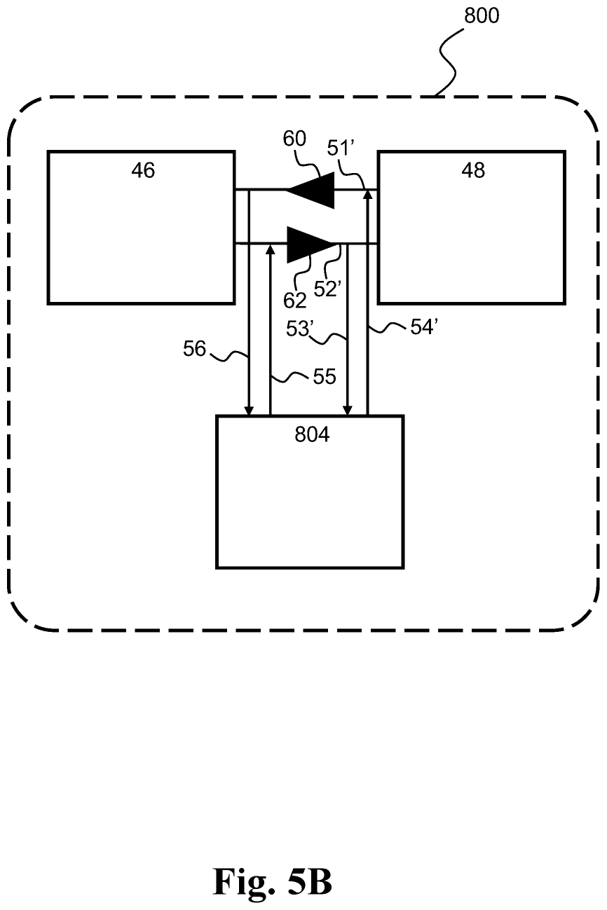

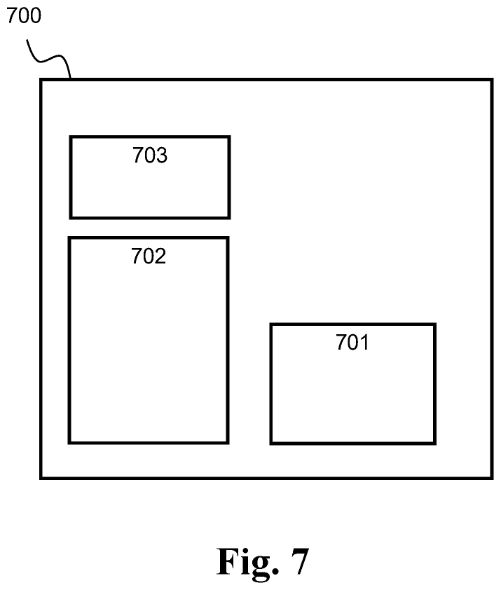

FIG. 2A-2B shows a flow diagram of an example method 100, performed by a coverage enhancing device, CED according to the disclosure. The method may be a method for enabling interference mitigation in a communication network. In other words, the method may be for improving inference detection and localization in a wireless communication network. It may be appreciated that the method may be for optimizing a beamforming of a CED, such as CED 800. The CED is the CED as disclosed herein, such as the CED 800 of FIG. 1, FIG. 4, FIGS. 5A-5B, and FIG. 7.

The method 100 comprises detecting S108 an interference in a signal received at the CED, such as CED 800. In other words, detecting S108 an interference in a signal received at the CED may comprise detecting S108 an interference in a signal using the CED, such as CED 800. The CED 800 may be configured to detect interference in a signal, such as a signal received by the CED 800. Detecting an interference in a signal may be seen as detecting that a signal has been interfered by an interfering signal. Interference in wireless communication, such as interference in a signal, may be seen as the presence of unwanted signals that can degrade the quality of a desired signal. When there is interference in a signal, the channel where the signal is communicated may be seen as an interference channel. Interference can be caused by various factors such as other wireless devices, remote radio network nodes, environmental factors, and/or electromagnetic radiation from other sources. Interference in a signal may be detected using various methods. For example, the detection of the interference may be performed using signal processing to analyze a received signal and identify unwanted signals that may be present. Another way of detecting interference in a signal is by observing the performance of the wireless communication system, such as intermittent wireless connections, slow performance, and/or decreased signal strength.

In one or more example methods, detecting S108 the interference comprises performing S108A one or more interference measurements. Performing S108A one or more interference measurements may comprise performing one or more interference measurements at the CED 800 using an interference management framework. For example, performing S108A one or more interference measurements may comprise performing one or more remote interference management, RIM, measurements and/or cross-link interference, CLI, measurements.

The method 100 comprises transmitting S110, to a node, information indicative of the interference detected by the CED. In other words, the method 100 comprises transmitting S110, using processor circuitry and/or via a wireless interface of the CED 800 to a node, information indicative of the interference detected by the CED. Transmitting S110 information indicative of the interference detected by the CED to a node may comprise transmitting a message comprising information indicative of the interference detected by the CED to a node. For example, the method 100 may comprise transmitting a message comprising a report indicative of and/or comprising the information. In one or more example methods, the message comprises information indicative of one or more beam identifications, IDs, of the CED.

The node may be seen as a node of the communication network. The node may be seen as a node involved in a communication via the interference channel, such as via the channel where interference was detected.

In one or more example methods, the node, such as node 700, is a radio network node, such as radio network node 400, and/or a CED controlling node. In other words, transmitting S110 information to a node may comprise transmitting information indicative of the interference detected by the CED to a radio network node, such as to radio network node 400, and/or to a CED controlling node. The radio network node may be a gNB. It may be appreciated that the radio network node may be the CED controlling node. The CED controlling node may be seen as or comprise one or more of: central management system, a base station, a network management server, or any other entity responsible for coordinating a deployment and operation of the CED.

In one or more example methods, detecting S108 the interference may comprise receiving an interference management framework signal from another node that is interfered, such as receiving a RIM and/or CLI framework signal from another node that is interfered. In one or more example methods, transmitting S110 information to the node may comprise transmitting a beacon indicative of the received signal. In one or more example methods, detecting S108 the interference may comprise measuring resources configured by the node 700, such as the CED controlling node. In one or more example methods, transmitting S110 information to the node may comprise transmitting information indicative of the measurement of resources.

In one or more example methods, detecting S108 the interference may comprise detecting an interference in UL direction and/or in DL direction. In other words, the CED 800 may be capable of distinguishing between interference in UL and DL direction. The CED 800 may use different antennas for detecting interference in the different directions. The information about the direction of where the interference has been detected may be transmitted to the node 700.

In one or more example methods, the node, such as node 700, is a wireless device, WD, such as wireless device 300. In other words, transmitting S110 information to a node may comprise transmitting information indicative of the interference detected by the CED to a wireless device, such as to the WD 300. The WD may be a user equipment device, UE. It may be appreciated that the WD may be the CED controlling node.

In one or more example methods, the method 100 comprises transmitting S104, to the node, such as node 700, information indicative of a capability of the CED to support interference management framework. In one or more example methods, the methods 100 comprises transmitting information indicative of a capability of the CED to support interference management framework to a radio network node, such as radio network node 400, a CED controlling node, and/or a wireless device, such as WD 300. The interference management framework may for example comprise the RIM and/or CLI framework. The information indicative of a capability of the CED to support interference management framework may comprise an explicit or implicit indication of whether the CED supports RIM and/or CLI detection. Transmitting S104 information indicative of a capability of the CED to support interference management framework may comprise transmitting, from the CED 800 to the node 700, a capability signal or an indirect indication if a capability is mandatory. An indirect indication may for example comprise an indication of which version of the interference management framework the CED 800 supports. It may be appreciated that a certain framework version may be mandatory for certain releases.

The information may be indicative of a capability of the CED to detect interference in the UL direction and/or the DL direction.

In one or more example methods, the method 100 comprises receiving S106, from the node, such as node 700, a first message instructing the CED, such as CED 800, to perform one or more interference measurements. The first message may be seen as a signal being indicative of and/or comprising instructions to the CED to perform one or more interference measurements. The first message may be indicative of and/or comprise instructions to the CED to perform one or more interference measurements using an interference management framework, such as using the RIM and/or CLI framework. The first message may be indicative of and/or comprise instructions to the CED indicative of a direction, such as UL and/or DL direction, in which the CED is to perform the one or more interference measurements. The first message may comprise a first measurement instruction signal. The first message may be received from the node 700 in response to the transmission of the information indicative of a capability of the CED to support interference management framework. The first message may be received in accordance with the CED being capable of supporting interference management framework. It may be appreciated that when the CED is not capable of supporting interference management framework, the node 700 may refrain from transmitting a message, such as refrain from transmitting the first message. The first message may be received from the node 700 acting as CED controlling node, such as the radio network node 400 and/or the wireless device acting as CED controlling node.

In one or more example methods, receiving S106 the first message may comprise receiving, from the node 700, a first configuration comprising a first set of interferer identities, IDs, for the CED to detect. In other words, the first message may comprise the first configuration. An interferer identity as described herein may be seen as a scrambling identity. For example, the first configuration may comprise an index comprising the first set of interferer IDs. Alternatively or additionally, the first configuration may comprise a selection of pre-configured interferer IDs to be detected by the CED and/or the first configuration may indicate one or more selection criteria indicating to the CED how to select a set of interferer IDs from interferer IDs known by the CED.

In one or more example methods, performing S108A the one or more interference measurements is based on the first message. For example, performing S108A the one or more interference measurements comprises performing the one or more interference measurements using an interference management framework, such as using the RIM and/or CLI framework.

In one or more example methods, performing S108A the one or more interference measurements is based on the first configuration, such as based on the first set of interferer IDs.

Based on as described herein may be seen as “a function of” and/or “used as an input to”. For example, the one or more interference measurements may be a function of the first message and/or the first message may be used as an input to perform the one or more measurements.

In one or more example methods, detecting S108 an interference in a signal received at the CED comprises detecting S108B an interference in a downlink, DL, signal from the communication network to the CED. For example, detecting S108 an interference in a signal received at the CED may comprise detecting S108B an interference in a downlink, DL, signal from the node 700 to the CED 800, such as from the radio network node 400 to the CED 800. Detecting S108 an interference in a signal received at the CED may comprise detecting an interference in a DL signal from the radio network node 400 to the WD 300 via the CED 800.

In one or more example methods, the CED 800 is configured to communicate with the network node 400 via a backhaul channel and/or a control channel. The backhaul channel and the control channel may use the same propagation channel. The backhaul channel may be denoted a B-channel and the control channel may be denoted a C-channel. In one or more example methods, the CED 800 is configured to communicate with the WD 300 via an access channel. The access channel may be denoted an A-channel.

In other words, detecting S108 an interference in a signal received at the CED may comprise detecting S108B an interference leaking into the B-channel and/or C-channel as described herein.

In one or more example methods, detecting S108 an interference in a signal received at the CED comprises detecting S108C an interference in an uplink, UL, signal from a wireless device to the CED.

For example, detecting S108 an interference in a signal received at the CED may comprise detecting S108C an interference in an UL signal from the WD 300 to the CED 800. Detecting S108 an interference in a signal received at the CED may comprise detecting an interference in a UL signal from the WD 300 to the radio network node 400 via the CED 800.

In other words, detecting S108 an interference in a signal received at the CED may comprise detecting S108C an interference leaking into the A-channel as described herein.

In one or more example methods, the method 100 comprises receiving S112, from the node 700, a second message comprising a configuration signal indicative of a beamforming configuration of the CED 800. In one or more example methods, the second message may be indicative of a mitigation strategy determined at the node 700. For example, the second message, such as the configuration signal, may configure the beamforming of the CED as part of a mitigation strategy for mitigating the detected interference. The beamforming configuration may comprise one or more settings for changing the beamforming configuration of the CED. For example, the beamforming configuration may change a beam shape at the CED. The node 700, such as the radio network node 400 and/or the wireless device 300, e.g., acting as CED controlling node, may take action based on the information indicative of interference detected by the CED by changing the beamforming configuration of the CED. In one or more example methods, the beamforming configuration may be based on the beam IDs transmitted via the message from the CED.

The second message may be seen as a signal being indicative of and/or comprising instructions to the CED to change beamforming configuration. The second message may be received from the node 700 in response to the transmission of the information indicative of the interference detected by the CED. The second message may be received in accordance with the node 700 having determined a beamforming configuration for the CED for mitigating the detected interference. The second message may be received from the node 700 acting as CED controlling node, such as the radio network node 400 and/or the wireless device acting as CED controlling node.

In one or more example methods, the second message may be indicative of and/or comprising instructions to the CED to perform one or more interference measurements using an interference management framework, such as using the RIM and/or CLI framework. For example, the second message may be indicative of and/or comprising instructions to the CED to perform one or more interference measurements using an interference management framework in response to the transmission of the information indicative of the interference detected by the CED. In other words, the second message may be indicative of and/or comprising instructions to the CED to perform a second iteration of one or more interference measurements.

In one or more example methods, the method 100 comprises applying S114 the beamforming configuration based on the second message. In other words, the CED 800 may be configured to change beamforming configuration based on the second message. For example, the CED 800 may be configured to apply one or more settings of the beamforming configuration for changing an actual beamforming configuration of the CED, e.g., for changing a beam shape of the CED. In one or more example methods, the information indicative of the interference detected by the CED comprises one or more of: information indicating whether the interference is UL or DL, properties of a timing overlap of an interfering signal, one or more detected interference management interferer identities, a time stamp for each of the one or more detected interference management interferer identities, and one or more properties of the interfering signal. In one or more example methods, the information indicative of the interference detected by the CED comprises information indicative of a CED beam ID.

The information may be detected by the CED 800 when performing the one or more interference measurements.

The information indicative of the interference detected by the CED may indicate whether the interference has been detected in an UL signal or a DL signal. In other words, the CED 800 may detect which panel of the CED antenna has been used to receive the signal.

Properties of a timing overlap of an interfering signal may be seen as a timing overlap of an interfering signal with respect to the interfered signal detected by the CED 800. For example, properties of a timing overlap of an interfering signal may be seen as a timing overlap of an UL signal and a DL signal.

An interference management interferer identity may for example be seen as an RIM interferer identity detected by the CED 800.

In one or more example methods, the one or more properties of the interfering signal may comprise information conveyed by a remote interference reference signal, RI-RS. This may for example be possible when the interfering node has turned on its beacon, e.g., for communicating with the CED 800.

In one or more example methods, the method 100 comprises transmitting S116, to the node, such as node 700, information indicative of the CEDs, such as CED 800, capability of autonomously communicating with an interferer node. This may for example be possible when the interfering node has turned on its beacon, e.g., for communicating with the CED 800, and the CED 800 is capable of communicating with the interferer node via the interfering channel. An interferer node may for example comprise a remote node, such as a remote radio network node and/or a remote wireless device.

In one or more example methods, the method 100 comprises receiving S118 in response to the information, from the node, a message indicative of whether the CED is authorized to communicate autonomously with the interferer node. In one or more example methods, the method 100 may comprise receiving a message, from the node 700, such as from the radio network node 400 and/or the WD 300, indicative of information on the interferer node and/or indicative of how the interference mitigation should be applied between the CED 800 and the interferer node. In other words, the message from the node 700 may indicate how the CED 800 should coordinate with the interferer node to apply the interference mitigation. For example, the message from the node 700 may indicate how the CED 800 should coordinate with the interferer node to resolve and/or mitigate the detected interference. In one or more example methods, the method 100 may comprise determining S120 whether the message is indicative of an authorization to communicate autonomously with the interferer node.

In one or more example methods, the method 100 comprises, in accordance with the message being indicative of an authorization of the CED to communicate with the interferer node, communicating S122 with the interferer node. Communicating S122 with the interferer node may comprise initiating a communication with the interferer node, such as at the CED 800 initiating a communication with the interferer node. For example, communicating S122 with the interferer node may comprise the CED 800 coordinating with the interferer node how interference mitigation should be applied. In other words, the CED 800 and the interferer node may coordinate which of the CED 800 and/or the interferer node shall mitigate the detected interference. For example, the CED 800 and the interferer node may coordinate which of the CED 800 and/or the interferer node shall use the interference management framework to mitigate the detected interference. The CED 800 and the interferer node may coordinate which of the CED 800 and/or the interferer node shall use the CLI/RIM framework to mitigate the detected interference. In one or more example methods, the method 100 comprises, in accordance with the message not being indicative of an authorization of the CED to communicate with the interferer node, refraining S121 from communicating with the interferer node.

In one or more example methods, the method 100 may comprise transmitting information indicative of the interference detected by the CED 800 to the interferer node.

In one or more example methods, the method 100 comprises communicating with the interferer node without the need for prior authorization. In other words, the CED 800 may be configured to communicate with the interferer node autonomously.

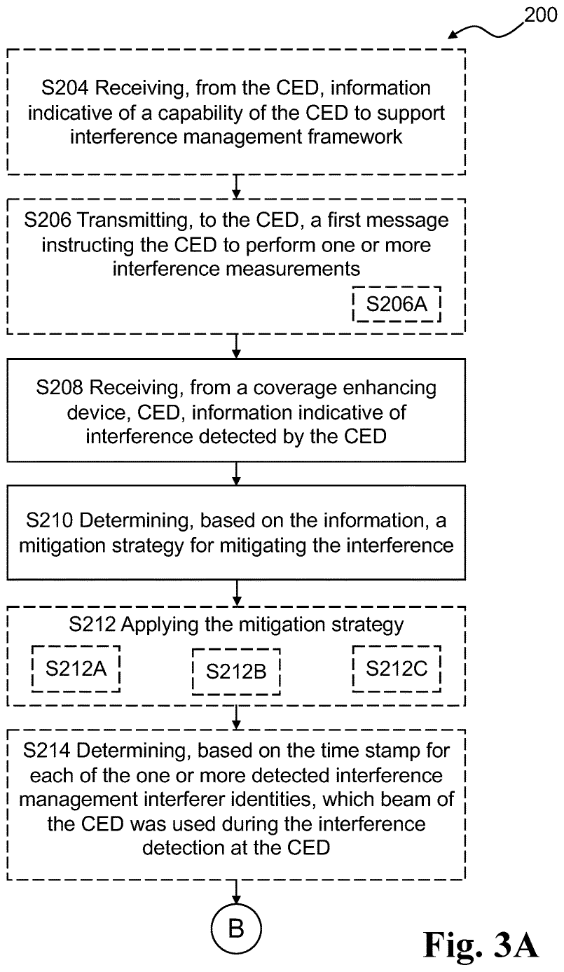

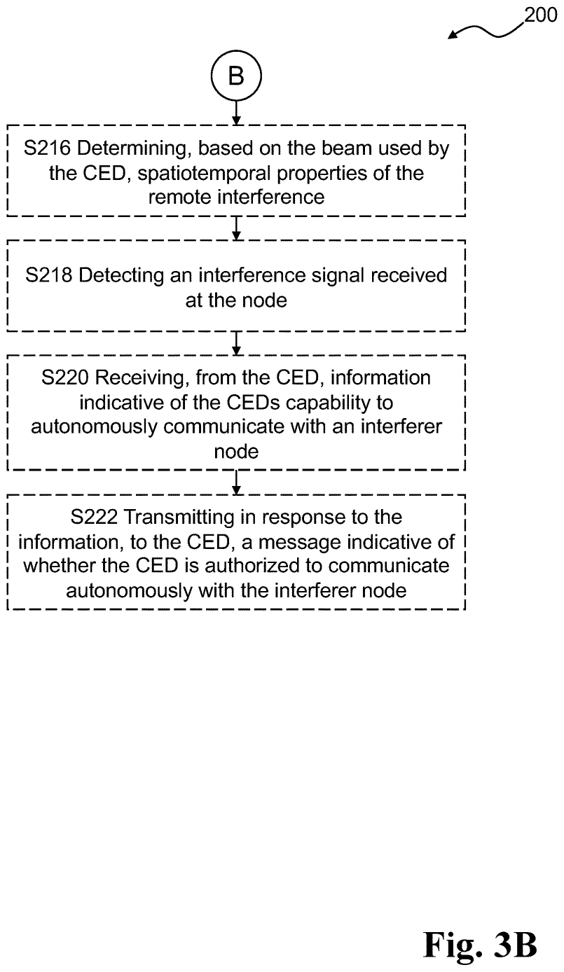

FIG. 3A-3B shows a flow diagram of an example method 200, performed in a node according to the disclosure, for enabling interference mitigation in a communication network. In other words, the method may be for improving inference detection and localization in a wireless communication network. It may be appreciated that the method may be for optimizing a beamforming of a CED, such as CED 800, and/or a beamforming of the node, such as node 700. The node is the node disclosed herein, such as node 700 of FIG. 1, FIG. 4, and FIG. 7. In one or more example methods, the node, such as node 700, may be a network node, such as radio network node 400, a CED controlling node as disclosed herein, and/or a wireless device, such as wireless device 300, of FIG. 1 and FIG. 4.

The method 200 comprises receiving S208, from a coverage enhancing device, CED, information indicative of interference detected by the CED, such as CED 800.

In other words, the method 200 comprises receiving S208, using processor circuitry and/or via a wireless interface of the node 700, from the CED 800, information indicative of the interference detected by the CED. Receiving S208 information indicative of the interference detected by the CED from the CED, may comprise receiving a message comprising information indicative of the interference detected by the CED. For example, the method 200 may comprise receiving a message comprising a report indicative of and/or comprising the information.

The node 700 may be seen as a node of the communication network, such as of the wireless communication system 1. The node 700 may be seen as a node involved in a communication via the interference channel, such as via the channel where interference was detected.

The method 200 comprises determining S210, based on the information, a mitigation strategy for mitigating the interference. A mitigation strategy may be seen as a strategy for mitigating interference in a wireless communication system, such as wireless communication system 1. A mitigation strategy may be seen as a set of methods, techniques, and/or tools used to reduce or eliminate signal interference in a wireless communication system. In one or more example methods, determining S210 a mitigation strategy may comprise determining a mitigation strategy at a radio network node, such as at radio network node 400, e.g., at a gNB. In one or more example methods, determining S210 a mitigation strategy may comprise determining a mitigation strategy at a wireless device, such as at WD 300.

In one or more example methods, the method 100 comprises applying S212 the mitigation strategy. Applying S212 the mitigation strategy may comprise determining, based on the mitigation strategy, a message comprising instructions on how to apply the mitigation strategy. In other words, the message may be indicative of the mitigation strategy. In one or more example methods, applying S212 the mitigation strategy may comprise sending or transmitting the message. For example, when the node 700 is the radio network node 400 and/or the CED controlling node, the method 100 may comprise sending the message to the CED 800 and/or the WD 300. For example, when the node 700 is the WD 300, the method 100 may comprise sending the message to the CED 800 and/or the radio network node 400. In one or more example methods, applying S212 the mitigation strategy may comprise sending the message to the interferer node.

In one or more example methods, the node is a radio network node, a wireless device, and/or a CED controlling node. In one or more example methods, the node 700 is the radio network node 400. In other words, receiving S208 information may comprise receiving information indicative of the interference detected by the CED at the radio network node, such as at the radio network node 400, from the CED 700. The radio network node may be a gNB.

In one or more example methods, the node 700 is the wireless device 300. In other words, receiving S208 information may comprise receiving information indicative of the interference detected by the CED at the wireless device, such as at the WD 300, from the CED 700.

In one or more example methods, the node 700 is the CED controlling node as disclosed herein, such as the radio network node 400 acting as the CED controlling node and/or a separate node acting as the CED controlling node. In other words, receiving S208 information may comprise receiving information indicative of the interference detected by the CED at the CED controlling node from the CED 700.

In one or more example methods, the method 200 comprises receiving S204, from the CED, such as CED 800, information indicative of a capability of the CED to support interference management framework. The interference management framework may for example comprise the RIM and/or CLI framework. The information indicative of a capability of the CED to support interference management framework may comprise an explicit or implicit indication of whether the CED supports RIM and/or CLI detection. Receiving S204 information indicative of a capability of the CED to support interference management framework may comprise receiving, from the CED 800 at the node 700, a capability signal or an indirect indication if a capability is mandatory. An indirect indication may for example comprise an indication of which version of the interference management framework the CED 800 supports. It may be appreciated that a certain framework version may be mandatory for certain releases.

In one or more example methods, the method 200 comprises transmitting S206, to the CED, such as CED 800, a first message instructing the CED to perform one or more interference measurements. The first message may be seen as a signal being indicative of and/or comprising instructions to the CED to perform one or more interference measurements. The first message may be indicative of and/or comprising instructions to the CED to perform one or more interference measurements using an interference management framework, such as using the RIM and/or CLI framework. The first message may comprise a first measurement instruction signal. The first message may be transmitted from the node 700 in response to the reception of the information indicative of a capability of the CED to support interference management framework. The first message may be transmitted in accordance with the CED being capable of supporting interference management framework. It may be appreciated that when the CED is not capable of supporting interference management framework, the node 700 may refrain from transmitting a message, such as refrain from transmitting the first message. The first message may be transmitted from the node 700 acting as CED controlling node, such as the radio network node 400 and/or the wireless device acting as CED controlling node.

In one or more example methods, the information indicative of the interference detected by the CED comprises one or more of: information indicating whether the interference is UL or DL, properties of a timing overlap of an interfering signal, one or more detected interference management interferer identities, a time stamp for each of the one or more detected interference management interferer identities, and one or more properties of the interfering signal. In one or more example methods, the information indicative of the interference detected by the CED comprises information indicative of a CED beam ID.

The information indicative of the interference detected by the CED may indicate whether the interference has been detected in an UL signal or a DL signal. In other words, the information may be indicative of which panel of the CED antenna has been used to receive the signal.

Properties of a timing overlap of an interfering signal may be seen as a timing overlap of an interfering signal with respect to the interfered signal detected by the CED 800. For example, properties of a timing overlap of an interfering signal may be seen as a timing overlap of an UL signal and a DL signal.

An interference management interferer identity may for example be seen as an RIM interferer identity detected by the CED 800.

In one or more example methods, the one or more properties of the interfering signal may comprise information conveyed by a remote interference reference signal, RI-RS. This may for example be possible when the interfering node has turned on its beacon, e.g., for communicating with the CED 800.

In one or more example methods, transmitting S206 the first message comprises transmitting S206A, to the CED, a configuration indicative of a set of interference management interferer identities for the CED to detect. An interferer, such as interferer node, as described herein may be seen as an aggressor.

In one or more example methods, transmitting S206 the first message comprises determining a configuration indicative of a set of interference management interferer identities for the CED to detect based on the one or more detected interference management interferers. It may be appreciated that the CED 800 may perform one or more iterations of interference measurements. In one or more example methods, the CED 800 may perform a first iteration of one or more interference measurements and a second iteration of one or more interference measurements in response to the reception of the first message.

The configuration may correspond to the configuration received at the CED as described herein.

In one or more example methods, transmitting S206 the first message may comprise transmitting, from the node 700, a first configuration comprising a first set of interferer identities, IDs, for the CED to detect. In other words, the first message may comprise the first configuration. An interferer identity, such as an interference management interferer identity, as described herein, may be seen as a scrambling identity. For example, the first configuration may comprise an index comprising the first set of interferer IDs. Alternatively or additionally, the first configuration may comprise a selection of pre-configured interferer IDs to be detected by the CED and/or the first configuration may indicate one or more selection criteria indicating to the CED how to select a set of interferer IDs from interferer IDs known by the CED.

In one or more example methods, transmitting S206 the first message may comprise transmitting, to the CED 800, resources to probe the interferer IDs.

In one or more example methods, the method 200 comprises determining S214, based on the time stamp for each of the one or more detected interference management interferer identities, which beam of the CED was used during the interference detection at the CED. For example, the method 200 comprises determining S214, based on the time stamp for each of the one or more detected RIM interferer identities, which beam of the CED was used during the interference detection at the CED

In one or more example methods, the method 200 comprises determining S216, based on the beam used by the CED, spatiotemporal properties of the remote interference. In one or more example methods, determining S210 the mitigation strategy comprises determining the mitigation strategy based on the spatiotemporal properties of the remote interference.

In one or more example methods, the method 200 comprises detecting S218 an interference in a signal received at the node, such as node 700. The node 700 being the radio network node 400 and/or the WD 300 may be configured to detect an interference signal.

In one or more example methods, detecting S218 an interference in a signal received at the node may comprise detecting an interference in a signal received at the node 700 acting as the radio network node 400. In other words, detecting S218 an interference in a signal received at the node may comprise detecting an interference in an UL signal received at the node 700 acting as the radio network node 400. Detecting S218 an interference in a signal received at the node 700 may comprise detecting an interference in an UL signal from the WD 300 to the radio network node 400 via the CED 800.

In other words, detecting S218 an interference in a signal received at the node acting as the radio network node 400 may comprise detecting an interference leaking into the B-channel and/or C-channel as described herein.

In one or more example methods, detecting S218 an interference in a signal received at the node may comprise detecting an interference in a signal received at the node 700 acting as the WD 300. In other words, detecting S218 an interference in a signal received at the node may comprise detecting an interference in a DL signal received at the node 700 acting as the WD 300. Detecting S218 an interference in a signal received at the node 700 may comprise detecting an interference in a DL signal from the radio network node 400 to the WD 300 via the CED 800.

In other words, detecting S218 an interference in a signal received at the node acting as the WD 300 may comprise detecting an interference leaking into the A-channel as described herein.

In one or more example methods, determining S210 the mitigation strategy is based on the detected interference at the node, such as node 700, and/or the information indicative of interference detected by the CED, such as CED 800. By combining information from a detected interference at the node and the information indicative of interference detected by the CED, it may be possible for the node to localize where the interference is introduced in the communication system. In other words, it may be possible for the node 700, such as the radio network node 400 and/or the WD 300, to distinguish between interference occurring between the WD 300 and the CED 800 and interference occurring between the radio network node 400 and the CED 800.

In one or more example methods, applying S212 the mitigation strategy comprises transmitting S212A, to the CED, a second message comprising a configuration signal indicative of a beamforming configuration of the CED based on the information indicative of the interference.

Transmitting S212A, to the CED, a second message comprising a configuration signal indicative of a beamforming configuration of the CED may be done in response to the information indicative of the interference indicating that the interference occurred in an UL signal transmitted by the WD 300 to the radio network node 400 via the CED 800. In other words, transmitting S212A the second message to the CED may happen when it is detected/determined that the interference has occurred in the A-channel. A beamforming configuration may be seen as a configuration comprising one or more settings for configuring a beamforming of the CED 800. A beamforming configuration may comprise: one or more beamforming angles, one or more beamforming weights, one or more CED gains for UL and/or DL retransmission, and/or one or more antenna configurations.

In one or more example methods, applying S212 the mitigation strategy comprises transmitting S212B an updated timing schedule to the CED. The node 700, such as the radio network node 400, the CED controlling node, and/or the WD 300, may be configured to determine an updated timing schedule, such as determine an updated timing schedule for the CED 800. An updated timing schedule may replace an existing timing schedule for mitigating interference in the wireless communication system. A timing schedule may comprise a synchronization configuration, e.g., for synchronizing an UL and/or DL transmission pattern. In one or more example methods, the method 200 may comprise adjusting the time domain of one or more nodes of the wireless communication system, such as the time domain of the radio network node 400, the CED 800, and/or the WD 300. It may be appreciated that time domain adjustment may be performed by transmitting an updated timing schedule.

It may be appreciated that the CED 800, the radio network node 400, and the WD 300 may operate with different timing schedules, such as different timing advances, TAs, when communicating on the wireless communication system. Accordingly, knowledge of an interference source may allow to mitigate interference, e.g., by changing a timing schedule in the wireless communication system. For example, transmitting S212B an updated timing schedule to the CED may comprise synchronizing an UL and/or DL transmission pattern, e.g., by configuring symbol slip or blanking.

In one or more example methods, applying S212 the mitigation strategy comprises instructing S212C the wireless device, such as WD 300, to apply countermeasures for mitigating the interference. The method 200 may comprise instructing the WD 300 to apply countermeasures according to the determined mitigation strategy. In other words, the node 700 may be configured to instruct the WD 300 to apply countermeasures for mitigating the interference. Instructing S212C the wireless device, such as WD 300, to apply countermeasures for mitigating the interference may comprise indicating to the WD 300 to apply countermeasures, such as instructing the WD 300 to use an interference management framework for mitigating the interference. For example, the method 200 may comprise instructing the WD 300 to use the RIM/CLI framework, e.g., where the WD 300 may communicate with the interferer node.

In one or more example methods, the method 200 comprises receiving S220, from the CED, information indicative of the CEDs capability to autonomously communicate with an interferer node. This may for example be possible when the interfering node has turned on its beacon, e.g., for communicating with the CED 800, and the CED 800 is capable of communicating with the interferer node via the interfering channel. An interferer node may for example comprise a remote node, such as a remote radio network node and/or a remote wireless device. When the CED is capable of acting autonomously, the CED may for example change beamforming configuration autonomously, update timing schedule autonomously, and/or instruct the WD to apply countermeasures for mitigating interference. It may be appreciated that the CED and the radio network node may agree how the CED should act autonomously.

In one or more example methods, the method 200 comprises transmitting S222 in response to the information, to the CED, a message indicative of whether the CED is authorized to communicate autonomously with the interferer node.

In one or more example methods, the method 200 may comprise transmitting a message, from the node 700, such as from the radio network node 400 and/or the WD 300, indicative of information on the interferer node and/or indicative of how the interference mitigation should be applied between the CED 800 and the interferer node. In other words, the message from the node 700 may indicate how the CED 800 should coordinate with the interferer node to apply the interference mitigation. For example, the message from the node 700 may indicate how the CED 800 should coordinate with the interferer node to resolve and/or mitigate the detected interference.

The message may for example comprise an authorization for the CED 800 to autonomously initiate a communication with the interferer node, such as at the CED 800 initiating a communication with the interferer node. For example, the message may comprise an authorization for the CED 800 to autonomously coordinate with the interferer node how interference mitigation should be applied. In other words, the CED 800 and the interferer node may coordinate which of the CED 800 and/or the interferer node shall mitigate the detected interference.

By providing an authorization, it may be avoided that the CED and the WD act autonomously at the same time. In one or more example methods, the method 200 may comprise indicating to the WD to refrain from acting, such as refrain from mitigating interference. For example, the WD cannot detect possible CED actions/signals toward the interferer while the CED receives signals from the WD. In one or more example methods, no WD is present in the wireless communication system and communicating with the CED. In this scenario, the CED may act autonomously, e.g., to ensure that the systems are synchronized when a WD enters an aera of the CED.

FIG. 4 is a diagram illustrating an example wireless communication system, such as wireless communication system 1, comprising an example network node 400, an example CED 800, and an example wireless device 300 according to this disclosure, where an example technique as disclosed herein is applied. The communication system 1 comprises a node 700. In one or more examples, the node 700 may be seen as the network node 400 and/or the wireless device 300. In one or more examples, the node 700 may be seen as a separate node, such as a CED controlling node and/or an interferer node.

In one or more examples, the CED 800 is configured to communicate with the network node 400 via a backhaul channel 43 and/or a control channel 41. The backhaul channel 43 and the control channel 41 may use the same propagation channel. The backhaul channel 43 may be denoted a B-channel and the control channel 41 may be denoted a C-channel. In one or more examples, the CED 800 is configured to communicate with the WD 300 via an access channel 45. The access channel 45 may be denoted an A-channel.

The CED 800 is configured to detect an interference in a signal received at the CED 800. The CED 800 is configured to transmit, to a node 700, information indicative of the interference detected by the CED 800. The node 700 is configured to receive, from the CED 800, information indicative of interference detected by the CED 800. The node 700 is configured to determine, based on the information, a mitigation strategy for mitigating the interference.

In one or more examples, detecting an interference in a signal received at the CED 800 comprises detecting an interference in a downlink, DL, signal from the communication network to the CED 800. For example, the CED 800 may be configured to detect an interference in a downlink, DL, signal from the node 700 to the CED 800, such as from the radio network node 400 to the CED 800. Detecting an interference in a signal received at the CED 800 may comprise detecting an interference in a DL signal from the radio network node 400 to the WD 300 via the CED 800. In other words, detecting an interference in a signal received at the CED 800 may comprise detecting an interference leaking into the B-channel 43 and/or C-channel 41 as described herein. An interferer node interfering a DL signal from the radio network node 400 to the WD 300 via the CED 800 may be seen as a-interferer 36 interfering 37 a DL signal from the radio network node 400 to the WD 300 via the CED 800. In one or more examples, the arrow with the interfering 37 may be seen as the act of interfering and/or the interfering signal.

In one or more examples, the CED 800 comprises a CED mobile termination, MT, circuitry 804 and/or a CED forwarding circuitry 805. In the example CED 800 shown in FIG. 4, the CED MT circuitry 804 is configured to access on the C-channel only. It may be appreciated that for this example the CED 800 is configured to detect interference on the C-channel 41 and to transmit information indicative of the detected interference to the radio network node 400 via the C-channel 41. This may also be seen in the example CED 800 shown in FIG. 5A. In the example CED 800 shown in FIG. 4, the CED forwarding circuitry 805 is configured to forward signals, such as forward and amplify, signals between the radio network node 400 and the WD 300 over the B-channel 43 and/or the A-channel 45.

The CED 800 may be configured to detect interference from the β-interferer 36 interfering 37 a DL signal from the radio network node 400 to the WD 300 via the CED 800.

An interferer node interfering a DL signal from the CED 800 to the WD 300 may be seen as a β2-interferer 34 interfering 35 a DL signal from the CED 800 to the WD 300. The WD 300 may be configured to detect interference from the β2-interferer 34 interfering 35 a DL signal from the CED 800 to the WD 300. In one or more examples, the arrow with the interfering 35 may be seen as the act of interfering and/or the interfering signal.

An interferer node interfering an UL signal from the CED 800 to the radio network node 400 may be seen as an α2-interferer 30 interfering 31 an UL signal from the CED 800 to the radio network node 400. The radio network node 400 may be configured to detect interference from the α2-interferer 30 interfering 31 an UL signal from the CED 800 to the radio network node 400. In one or more examples, the arrow with the interfering 31 may be seen as the act of interfering and/or the interfering signal.

In one or more examples, detecting an interference in a signal received at the CED 800 comprises detecting an interference in an uplink, UL, signal from the wireless device 300 to the CED 800.

For example, the CED 800 may be configured to detect an interference in an UL signal from the WD 300 to the CED 800. Detecting an interference in a signal received at the CED 800 may comprise detecting an interference in an UL signal from the WD 300 to the radio network node 400 via the CED 800. In other words, detecting an interference in a signal received at the CED 800 may comprise detecting an interference leaking into the A-channel 45 as described herein. An interferer node interfering an UL signal from the WD 300 to the radio network node 400 via the CED 800 may be seen as an α-interferer 32 interfering 33 an UL signal from the WD 300 to the CED 800. In one or more examples, the arrow with the interfering 33 may be seen as the act of interfering and/or the interfering signal.

In one or more examples, the CED 800, such as the CED MT circuitry 804, may be configured to access the A-channel 45. It may be appreciated that for this example the CED 800 is also configured to detect interference on the A-channel 45 and to transmit information indicative of the detected interference to the radio network node 400, e.g., via the C-channel 41. This may also be seen in the example CED 800 shown in FIG. 5B. In the example CED 800 shown in FIG. 4, the CED forwarding circuitry 805 is configured to forward signals, such as forward and amplify, signals between the radio network node 400 and the WD 300 over the B-channel 43 and/or the A-channel 45.

FIGS. 5A-5B are diagrams illustrating example CEDs according to this disclosure.

FIG. 5A shows a first configuration example of a CED 800 according to the disclosure. In the first configuration example of FIG. 5A, the CED 800 comprises a CED mobile terminating, MT, circuitry 804.

In the first configuration example of FIG. 5A, the CED 800 comprises an UL amplifier 60 configured to amplify signals received at a first radio frequency, RF, interface 48, e.g., signals received from the WD 300. In the first configuration example of FIG. 5A, the CED 800 comprises a DL amplifier 62 configured to amplify signals received at a second radio frequency, RF, interface 46, e.g., signals received from the radio network node 400. The two amplifiers 60 and 62 may be seen as the CED forwarding circuitry as described herein. The CED MT 804 and the CED forwarding circuitry may share the first RF interface 48 and/or the second RF interface 46. In this example, the CED MT 804 may only have access to the second RF interface 46. The CED MT, circuitry 804 may be configured to transmit signals 54 via the amplifier 60 and the second RF interface 46 in UL mode to the radio network node 400, such as via the C-channel and/or the B-channel. It may be appreciated that for the first configuration example the CED MT circuitry 804 may configured to access the C-channel only. For this example, the CED 800 is configured to detect 53 interference in a signal 52, e.g., on the C-channel, in DL mode and to transmit information indicative of the detected interference to the radio network node 400, e.g., via the C-channel and the signal 54 and signal 51 in UL mode. In this example, the CED 800 is configured to forward signals 51, 52, such as forward and amplify, between the radio network node 400 and the WD 300 from the B-channel to the A-channel in DL mode and/or from the A-channel to the B-channel in UL mode.

FIG. 5B shows a second configuration example of a CED 800 according to the disclosure. In the second configuration example of FIG. 5B, the CED 800 comprises a CED mobile terminating, MT, circuitry 804. In the second configuration example of FIG. 5B, the CED 800 comprises an UL amplifier 60 configured to amplify signals received at a first radio frequency, RF, interface 48, e.g., signals received from the WD 300. In the second configuration example of FIG. 5B, the CED 800 comprises a DL amplifier 62 configured to amplify signals received at a second radio frequency, RF, interface 46, e.g., signals received from the radio network node 400. The two amplifiers 60 and 62 may be seen as the CED forwarding circuitry as described herein. The CED MT 804 and the CED forwarding circuitry may share the first RF interface 48 and the second RF interface 46.

In the second configuration example of FIG. 5B, the CED MT, circuitry 804 may be configured to transmit signals 54 via the amplifier 60 and the second RF interface 46 in UL mode to the radio network node 400, such as via the C-channel. The CED MT circuitry 804 may be configured to transmit signals 55 via the amplifier 62 and the first RF interface 48 in DL mode to the WD 300, such as via the A-channel.

The second configuration example of the CED 800 may be seen as an enhanced CED 800 since the CED 800 of the second configuration example is capable of detecting interference both in DL mode and in UL mode. Further, the CED 800 of the second configuration example is capable of transmitting information indicative of the detection to both the radio network node 400 and the WD 300. It may be appreciated that for the second configuration example the CED MT circuitry 804 may be configured to access the C-channel and the A-channel. For this example, the CED 800 is configured to detect 53′ interference in a signal 52′, e.g., on the C-channel, in DL mode and to transmit information indicative of the detected interference to the radio network node 400, e.g., via the C-channel and the signal 54′ and signal 51′ in UL mode. For this example, the CED 800 is configured to detect 56 interference in a signal 51′, e.g., on the A-channel, in UL mode and to transmit information indicative of the detected interference to the WD 300, e.g., via the A-channel and the signal 55 and signal 52′ in DL mode and/or to transmit information indicative of the detected interference to the radio network node 400 via the C-channel in UL mode.

In this example, the CED 800 is configured to forward signals 51, 52, such as forward and amplify, between the radio network node 400 and the WD 300 from the B-channel to the A-channel in DL mode and/or from the A-channel to the B-channel in UL mode.

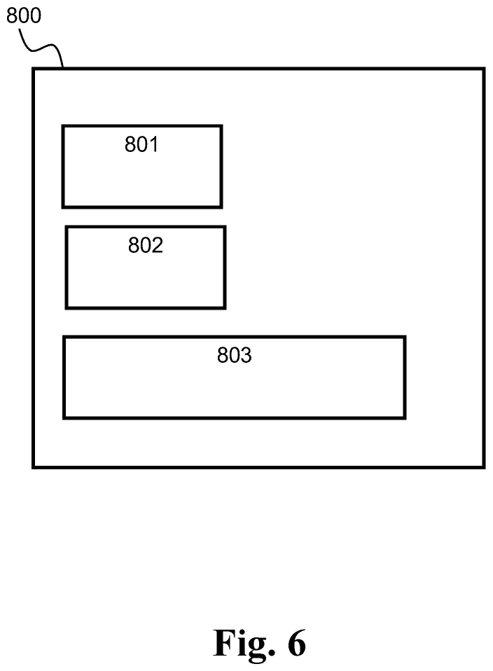

FIG. 6 shows a block diagram of an example CED 800 according to the disclosure. The CED 800 comprises memory circuitry 801, processor circuitry 802, and a wireless interface 803. The CED 800 may be configured to perform any of the methods disclosed in FIGS. 2A-B. In other words, the CED 800 may be configured enabling interference mitigation in a communication network.

The CED 800 is configured to communicate with a node, such as the node 700 disclosed herein, e.g., radio network node 400, wireless device 300, and CED controlling node, using a wireless communication system.

The wireless interface 803 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands, such as NTN and/or sidelink communication.

The CED 800 is configured to detect, for example via the wireless interface 803 and/or using the processor circuitry 802, an interference in a signal received at the CED. The CED 800 is configured to transmit, for example via the wireless interface 803 and/or using the processor circuitry 802, to a node, information indicative of the interference detected by the CED.

Processor circuitry 802 is optionally configured to perform any of the operations disclosed in FIGS. 2A-B (such as any one or more S104, S106, S108, 108A, S108B, S108C, S110, S112, S114, S116, S118, S120, S121, S122). The operations of the CED 800 may be embodied in the form of executable logic routines (for example, lines of code, software programs, etc.) that are stored on a non-transitory computer readable medium (for example, memory circuitry 801) and are executed by processor circuitry 802).

Furthermore, the operations of the CED 800 may be considered a method that the CED 800 is configured to carry out and vice-versa. Also, while the described functions and operations may be implemented in software, such functionality may also be carried out via dedicated hardware or firmware, or some combination of hardware, firmware and/or software.

Memory circuitry 801 may be one or more of a buffer, a flash memory, a hard drive, a removable media, a volatile memory, a non-volatile memory, a random access memory (RAM), or other suitable device. In a typical arrangement, memory circuitry 801 may include a non-volatile memory for long term data storage and a volatile memory that functions as system memory for processor circuitry 802. Memory circuitry 801 may exchange data with processor circuitry 802 over a data bus. Control lines and an address bus between memory circuitry 801 and processor circuitry 802 also may be present (not shown in FIG. 6). Memory circuitry 801 is considered a non-transitory computer readable medium.

Memory circuitry 801 may be configured to store information indicative of interference, beamforming configuration, and/or information on interference management framework in a part of the memory.

FIG. 7 shows a block diagram of an example node 700 according to the disclosure. The node 700 comprises memory circuitry 701, processor circuitry 702, and a wireless interface 703. The node 700 may be configured to perform any of the methods disclosed in FIGS. 3A-3B. In other words, the node 700 may be configured for enabling interference mitigation in a communication network. In one or more example nodes, the node 700 may be seen as the network node 400 and/or the wireless device 300. In one or more example nodes, the node 700 may be seen as a separate node, such as a CED controlling node and/or an interferer node.

The node 700 is configured to communicate using a wireless communication system as disclosed herein.

The wireless interface 703 is configured for wireless communications via a wireless communication system, such as a 3GPP system, such as a 3GPP system supporting one or more of: New Radio, NR, Narrow-band IoT, NB-IoT, and Long Term Evolution—enhanced Machine Type Communication, LTE-M, millimeter-wave communications, such as millimeter-wave communications in licensed bands, such as device-to-device millimeter-wave communications in licensed bands, such as NTN and/or sidelink communication.

The node 700 is configured to receive, such as via the wireless interface 703, from a coverage enhancing device, CED, information indicative of interference detected by the CED.

The node 700 is configured to determine, such as using the processor circuitry 702, based on the information, a mitigation strategy for mitigating the interference.

The 700 is optionally configured to perform any of the operations disclosed in FIGS. 3A-3B (such as any one or more of S204, S206, S206A, S208, S210, S212, S212A, S212B, S212C, S214, S216, S218, S220, S222). The operations of the node 700 may be embodied in the form of executable logic routines (for example, lines of code, software programs, etc.) that are stored on a non-transitory computer readable medium (for example, memory circuitry 701) and are executed by processor circuitry 702).

Furthermore, the operations of the node 700 may be considered a method that the node 700 is configured to carry out and vice-versa. Also, while the described functions and operations may be implemented in software, such functionality may also be carried out via dedicated hardware or firmware, or some combination of hardware, firmware and/or software.

Memory circuitry 701 may be one or more of a buffer, a flash memory, a hard drive, a removable media, a volatile memory, a non-volatile memory, a random access memory (RAM), or other suitable device. In a typical arrangement, memory circuitry 701 may include a non-volatile memory for long term data storage and a volatile memory that functions as system memory for processor circuitry 702. Memory circuitry 701 may exchange data with processor circuitry 702 over a data bus. Control lines and an address bus between memory circuitry 01 and processor circuitry 702 also may be present (not shown in FIG. 7). Memory circuitry 701 is considered a non-transitory computer readable medium.

Memory circuitry 701 may be configured to store information, such as information indicative of interference, beamforming configuration, information related to mitigation strategy, and/or information on interference management framework in a part of the memory.

Examples of methods and products (CED and node) according to the disclosure are set out in the following items:
Item 1. A method performed in a coverage enhancing device, CED, for enabling interference mitigation in a communication network, the method comprising:
   detecting (S108) an interference in a signal received at the CED; and
   transmitting (S110), to a node, information indicative of the interference detected by the CED.
Item 2. The method according to item 1, wherein the node is a radio network node and/or a CED controlling node.
Item 3. The method according to item 1, wherein the node is a wireless device.
Item 4. The method according to any of the previous items, the method comprising:
   transmitting, to the node, information indicative of a capability of the CED to support interference management framework.
Item 5. The method according to any of the previous items, wherein detecting the interference comprises performing one or more interference measurements.
Item 6. The method according to item 5, the method comprising:
   receiving, from the node, a first message instructing the CED to perform one or more interference measurements; and
   wherein performing the one or more interference measurements is based on the first message.
Item 7. The method according to any of the previous items, wherein detecting an interference in a signal received at the CED comprises detecting an interference in a downlink, DL, signal from the communication network to the CED.
Item 8. The method according to any of the previous items, wherein detecting an interference in a signal received at the CED comprises detecting an interference in an uplink, UL, signal from a wireless device to the CED.
Item 9. The method according to any of the previous items, the method comprising:
   receiving, from the node, a second message comprising a configuration signal indicative of a beamforming configuration of the CED; and
   applying the beamforming configuration based on the second message.
Item 10. The method according to any of the previous items, wherein the information indicative of the interference detected by the CED comprises one or more of: information indicating whether the interference is UL or DL, properties of a timing overlap of an interfering signal, one or more detected interference management interferer identities, a time stamp for each of the one or more detected interference management interferer identities, and one or more properties of the interfering signal.
Item 11. The method according to any of the previous items, the method comprising:
   transmitting, to the node, information indicative of the CEDs capability of autonomously communicating with an interferer node;
   receiving in response to the information, from the node, a message indicative of whether the CED is authorized to communicate autonomously with the interferer node; and
   in accordance with the message being indicative of an authorization of the CED to communicate with the interferer node, communicating with the interferer node.
Item 12. A method performed in a node for enabling interference mitigation in a communication network, the method comprising:
   receiving (S208), from a coverage enhancing device, CED, information indicative of interference detected by the CED; and
   determining (S210), based on the information, a mitigation strategy for mitigating the
Item 13. The method according to item 12, the method comprising:
   applying the mitigation strategy.
Item 14. The method according to any of items 12-13, wherein the node is a radio network node, a wireless device, and/or a CED controlling node.
Item 15. The method according to any of items 12-14, the method comprising:
   receiving, from the CED, information indicative of a capability of the CED to support interference management framework.
Item 16. The method according to any of items 12-15, the method comprising:
   transmitting, to the CED, a first message instructing the CED to perform one or more interference measurements.
Item 17. The method according to any of items 12-16, wherein the information indicative of the interference detected by the CED comprises one or more of: information indicating whether the interference is UL or DL, properties of a timing overlap of an interfering signal, one or more detected interference management interferer identities, a time stamp for each of the one or more detected interference management interferer identities, and one or more properties of the interfering signal.
Item 18. The method according to items 16 and 17, wherein transmitting the first message comprises transmitting, to the CED, a configuration indicative of a set of interference management interferer identities for the CED to detect.
Item 19. The method according to any of items 17-18, the method comprising:
   determining, based on the time stamp for each of the one or more detected interference management interferer identities, which beam of the CED was used during the interference detection at the CED; and
   determining, based on the beam used by the CED, spatiotemporal properties of the remote interference.
Item 20. The method according to any of items 12-19, the method comprising:
   detecting an interference signal received at the node; and
   wherein determining the mitigation strategy is based on the detected interference at the node and the information indicative of interference detected by the CED.
Item 21. The method according to any of items 13-20, wherein applying the mitigation strategy comprises transmitting, to the CED, a second message comprising a configuration signal indicative of a beamforming configuration of the CED based on the information indicative of the interference.
Item 22. The method according to any of items 13-21, wherein applying the mitigation strategy comprises transmitting an updated timing schedule to the CED.
Item 23. The method according to any of items 13-22, wherein applying the mitigation strategy comprises instructing the wireless device to apply countermeasures for mitigating the interference.
Item 24. The method according to any of items 12-23, the method comprising:
   receiving, from the CED, information indicative of the CEDs capability to autonomously communicate with an interferer node; and
   transmitting in response to the information, to the CED, a message indicative of whether the CED is authorized to communicate autonomously with the interferer node.
Item 25. A coverage enhancing device, CED, (800) comprising memory circuitry (801), processor circuitry (802), and a wireless interface (803), wherein the CED (800) is configured to perform any of the methods according to any of Items 1-11.
Item 26. A node, (700) comprising memory circuitry (701), processor circuitry (702), and a wireless interface (703), wherein the node (700) is configured to perform any of the methods according to any of Items 12-24.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-11 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed in a coverage enhancing device, for enabling interference mitigation in a communication network, the method comprising:
detecting an interference in a signal received at the CED; and
transmitting to a node, information indicative of the interference detected by the CED.

2. The method according to claim 1, wherein the node is a radio network node and/or a CED controlling node, or the node is a wireless device.

3. (canceled)

4. The method according to claim 1, the method comprising:
transmitting, to the node, information indicative of a capability of the CED to support interference management framework.

5. The method according to claim 1, wherein detecting the interference comprises performing one or more interference measurements.

6. The method according to claim 5, the method comprising:
receiving, from the node, a first message instructing the CED to perform one or more interference measurements; and
wherein performing the one or more interference measurements is based on the first message.

7. The method according to claim 1, wherein detecting an interference in a signal received at the CED comprises detecting an interference in a downlink, DL, signal from the communication network to the CED, and/or wherein detecting an interference in a signal received at the CED comprises detecting an interference in an uplink, UL, signal from a wireless device to the CED.

8. (canceled)

9. The method according to claim 1, the method comprising:
receiving, from the node, a second message comprising a configuration signal indicative of a beamforming configuration of the CED; and
applying the beamforming configuration based on the second message.

10. The method according to claim 1, wherein the information indicative of the interference detected by the CED comprises one or more of: information indicating whether the interference is UL or DL, properties of a timing overlap of an interfering signal, one or more detected interference management interferer identities, a time stamp for each of the one or more detected interference management interferer identities, and one or more properties of the interfering signal.

11. The method according to claim 1, the method comprising:
transmitting, to the node, information indicative of the CEDs capability of autonomously communicating with an interferer node;
receiving in response to the information, from the node, a message indicative of whether the CED is authorized to communicate autonomously with the interferer node; and
in accordance with the message being indicative of an authorization of the CED to communicate with the interferer node, communicating with the interferer node.

12. A method performed in a node for enabling interference mitigation in a communication network, the method comprising:
receiving, from a coverage enhancing device (CED) information indicative of interference detected by the CED; and
determining, based on the information, a mitigation strategy for mitigating the interference.

13. The method according to claim 12, the method comprising:
applying the mitigation strategy.

14. The method according to claim 12, wherein the node is a radio network node, a wireless device, and/or a CED controlling node.

15. The method according to claim 12, method comprising:
receiving, from the CED, information indicative of a capability of the CED to support interference management framework; and/or
transmitting, to the CED, a first message instructing the CED to perform one or more interference measurements; wherein transmitting the first message comprises transmitting, to the CED, a configuration indicative of a set of interference management interferer identities for the CED to detect.

16. (canceled)

17. The method according to claim 12, wherein the information indicative of the interference detected by the CED comprises one or more of: information indicating whether the interference is UL or DL, properties of a timing overlap of an interfering signal, one or more detected interference management interferer identities, a time stamp for each of the one or more detected interference management interferer identities, and one or more properties of the interfering signal.

18. (canceled)

19. The method according to claim 17, the method comprising:
determining, based on the time stamp for each of the one or more detected interference management interferer identities, which beam of the CED was used during the interference detection at the CED; and
determining, based on the beam used by the CED, spatiotemporal properties of the remote interference.

20. The method according to claim 12, the method comprising:
detecting an interference signal received at the node; and
wherein determining the mitigation strategy is based on the detected interference at the node and the information indicative of interference detected by the CED.

21. The method according to claim 13, wherein applying the mitigation strategy comprises transmitting, to the CED, a second message comprising a configuration signal indicative of a beamforming configuration of the CED based on the information indicative of the interference, and/or wherein applying the mitigation strategy comprises transmitting an updated timing schedule to the CED; and/or wherein applying the mitigation strategy comprises instructing the wireless device to apply countermeasures for mitigating the interference.

22. (canceled)

23. (canceled)

24. The method according to claim 12, the method comprising:
receiving, from the CED, information indicative of the CEDs capability to autonomously communicate with an interferer node; and
transmitting in response to the information, to the CED, a message indicative of whether the CED is authorized to communicate autonomously with the interferer node.

25. A coverage enhancing device (CED) comprising memory circuitry, processor circuitry, and a wireless interface, wherein the CED is configured to perform the method of claim 1.

26. A node, comprising memory circuitry, processor circuitry, and a wireless interface, wherein the node is configured to perform the method of claim 12.
